(19) United States
(12) Patent Application Publication
(10) Pub. No.: US 2016/0092930 A1
(43) Pub. Date: Mar. 31, 2016

(54) METHOD AND SYSTEM FOR GATHERING DATA FOR TARGETED ADVERTISEMENTS

(71) Applicant: Kast Inc., San Diego, CA (US)

(72) Inventors: Yuja Chang, San Diego, CA (US); Suman Kanuganti, San Diego, CA (US); Robin Bisarya, San Diego, CA (US)

(21) Appl. No.: 14/500,318

(22) Filed: Sep. 29, 2014

(51) Int. Cl. G06Q 30/02; G02B 27/01; G06F 17/30

(52) U.S. Cl. CPC G06Q 30/0269; G06F 17/3079; G06F 17/30867; G02B 27/0172; G02B 2027/0178

(57) ABSTRACT

The present disclosure provides a method and system for collecting data for targeted advertisements. The method includes detecting a stare at a first set of products of one or more products for a user wearing an interactive wearable device with an integrated processor based on a plurality of pre-defined conditions; capturing an image of each of the stared first set of products of the one or more products; collecting a real time location coordinate of the user from the worn interactive head mounted optical device with an integrated processor; and storing the real time location coordinate of the user, a plurality of attributes of each of the captured image of each of the first set of products, and a profile information of the user.

### TECHNICAL FIELD

The present invention relates to the field of computer devices that are configured as wearable glasses and, in particular, relates to gathering data from these computer devices for targeting/re-targeting of advertisements.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. In the last decade, with the advent of Internet, advertising over more interactive media has become popular. For example, as the number of people using the Internet has exploded, advertisers have come to appreciate digital media and services offered over the Internet as a potentially powerful way to advertise.

Advertisers, ad exchanges, publishers, and the like have developed several strategies in an attempt to maximize the value of digital advertising. One such common phenomenon to maximize the value from advertising is to understand the attributes associated with the user (shopper) and provide him/her with advertisement matching his/her attributes. The attributes of the user can be age, gender, interests, geography, likes, dislikes, hobbies, social status, marital status, academic profile, and the like. One such attribute which plays an important role while converting a digital advertisement into revenue is his/her recent interest towards a particular product segment.

Typically, these digital media agencies collect the data related to the users using digital methods like dropping a cookie when the user browses on his/her portable communication device to collect his/her browsing information, fetching data from his social networking profile, collecting data from his/her mobile phone utilizing digital fingerprinting and the like. However, most of the traditional shoppers do not shop online. Instead, these shoppers prefer to make purchase in physical retail stores. These shoppers may browse the items online first to decide what they want, however, the digital advertisement agencies never know if the users made the purchase or not. In addition, these digital media agencies cannot have access to the actual shopping habits, items interested, shopping center visited and other info from traditional shoppers that are critical for a higher return of investment of an advertisement campaign.

Of late, there have been some solutions which are developed to track the user from his/her mobile phone to track his/her location in a retail store/physical store and construe his/her shopping habits. One such solution is to track users' movements by following the Wi-Fi signals from their respective smartphones. Another such solution utilizes crunching users' data from a variety of sources, including from video surveillance, passive Wi-Fi tracking, point-of-sale systems, workforce management tools, credit card transactions, and the like in a retail store. However, the above stated solutions collects majority of the data from in-store camera which do not have enough capabilities to distinguish individuals. Even if this data collection is improved by pairing shopper's cell phone Wifi or bluetooth with video cameras, the data is not accurate enough as the stores can only know if users make the purchase or not. The above stated technologies do not consider the spending time on the item(s) these users are interested by human nature.

In light of the above stated discussion, there is a need of a method and system which overcomes the above stated disadvantages.

### SUMMARY

In an aspect of the present disclosure, a method and system for collecting data for targeted advertisements is provided. The method includes detecting a stare at a first set of products of one or more products for a user wearing an interactive wearable device with an integrated processor based on a plurality of pre-defined conditions; capturing an image of each of the stared first set of products of the one or more products; collecting a real time location coordinate of the user from the worn interactive head mounted optical device with an integrated processor; and storing the real time location coordinate of the user, a plurality of attributes of each of the captured image of each of the first set of products, and a profile information of the user.

In an embodiment of the present disclosure, the method further includes processing the image of each of the stared first set of products to fetch the plurality of attributes of each of the captured image of each of the first set of products.

In another embodiment of the present disclosure, the method further includes analyzing the collected real time location coordinate of the user and the captured image of each of the stared first set of products.

In yet another embodiment of the present disclosure, at least one of the plurality of pre-defined conditions is based on a threshold time duration.

In yet another embodiment of the present disclosure, the method further includes transmitting the real time location coordinate of the user, the plurality of attributes of each of the captured image of each of the first set of products, and the profile information of the user to a server.

In yet another embodiment of the present disclosure, the method further includes creating a database by collecting the real time location coordinate of one or more users wearing the corresponding interactive head mounted optical device with an integrated processor, the plurality of attributes of each of the captured image of each of the first set of products stared by each of the one or more users, and the profile information of each of the one or more users.

In yet another embodiment of the present disclosure, the method further includes transmitting the database to at least one of a third party for targeted advertisement.

In another aspect of the present disclosure, a method for collecting data for targeted advertisements is provided. The method includes enabling detection of a stare for a first set of products of one or more products for each of one or more users by a corresponding interactive wearable device with an integrated processor based on a plurality of pre-defined conditions; triggering capturing of an image of each of the stared first set of products of the one or more products; receiving real time location coordinate of the one or more users, a plurality of attributes of each of the captured image of each of the first set of products, and a profile information of each of the one or more users; creating a database of the real time location coordinate of the one or more users, the plurality of attributes of each of the captured image of each of the first set of products, and the profile information of each of the one or more users; and transmitting the database to a third party for the targeted advertisement.

In an embodiment of the present disclosure, the captured image of each of the stared first set of products is processed by the corresponding interactive wearable device with an integrated processor to fetch the plurality of attributes of each of the captured image of each of the first set of products.

In another embodiment of the present disclosure, the collected real time location coordinate of the one or more users and the captured image of each of the stared first set of products are analyzed by the corresponding interactive wearable device with an integrated processor.

In yet another embodiment of the present disclosure, creating the database includes receiving the stored real time location coordinate of the one or more users, the plurality of attributes of each of the captured image of each of the first set of products, and the profile information of each of the one or more users.

In yet another embodiment of the present disclosure, at least one of the plurality of pre-defined conditions is based on a threshold time duration.

In yet another embodiment of the present disclosure, creating the database includes processing the real time location coordinate of the one or more users, the plurality of attributes of each of the captured image of each of the first set of products, and the profile information of each of the one or more users to generate a pre-determined set of reports.

In yet another aspect of the present disclosure, a system for collecting data for targeted advertisements is provided. The system includes a server and one or more interactive wearable device with an integrated processor worn by a corresponding one or more users. The interactive wearable device with an integrated processor includes a detection module to detect a stare at a first set of products of one or more products for the user wearing the interactive wearable device with an integrated processor based on a plurality of pre-defined conditions, an image capturing module to capture an image of each of the stared first set of products of the one or more products, a collection module to collect a real time location coordinate of the user from the worn interactive head mounted optical device with an integrated processor and a storing module to store the real time location coordinate of the user, a plurality of attributes of each of the captured image of each of the first set of products, and a profile information of the user.

In an embodiment of the present disclosure, the interactive wearable device with an integrated processor further includes a transmission module to transmit the real time location coordinate of the corresponding user, the plurality of attributes of each of the captured image of each of the first set of products, and the profile information of the corresponding user.

The server receives the real time location coordinate of the one or more users, the plurality of attributes of each of the captured image of each of the first set of products, and the profile information of each of the one or more users and create a database of the real time location coordinate of the one or more users, the plurality of attributes of each of the captured image of each of the first set of products, and the profile information of each of the one or more users.

In another embodiment of the present disclosure, the server transmits the database to at least one of a third party for targeted advertisement.

In yet another embodiment of the present disclosure, each of the one or more interactive wearable devices with an integrated processor processes the image of each of the stared first set of products to fetch the plurality of attributes of each of the captured image of each of the first set of products.

In yet another embodiment of the present disclosure, each of the one or more interactive wearable devices with an integrated processor analyzes the collected real time location coordinate of the user and the captured image of each of the stared first set of products.

In yet another embodiment of the present disclosure, at least one of the plurality of pre-defined conditions is based on a threshold time duration.

### BRIEF DESCRIPTION OF THE FIGURES

Having thus described the invention in general terms, reference will now be made to the accompanying drawings, which are not necessarily drawn to scale, and wherein:

FIG. 1 illustrates a system for collecting data for targeting/re-targeting of advertisements, in accordance with various embodiments of the present disclosure;

FIG. 2 illustrates a flowchart for collecting the data for the targeting/re-targeting of advertisements, in accordance with various embodiments of the present disclosure;

FIG. 3 illustrates a system for showing an interaction between block diagrams of an interactive wearable device and an application server, in accordance with various embodiments of the present disclosure; and

FIG. 4 illustrates a flowchart for processing the data for the targeting/re-targeting of advertisements, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

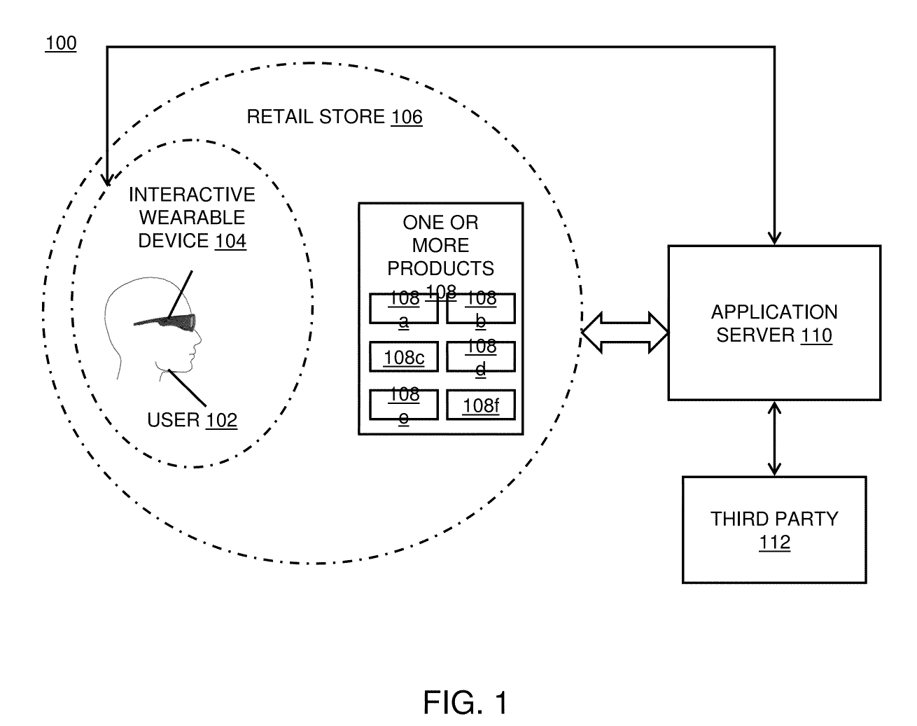

FIG. 1 illustrates a system 100 for gathering data for targeting/re-targeting of advertisements, in accordance with various embodiments of the present disclosure. The system 100 includes a user 102 wearing an interactive wearable device 104 with an integrated processor. In an embodiment of the present disclosure, the interactive wearable device 104 is a device worn on the user's 102 head with a screen in front of eyes that displays information like smart-phones. Examples of the interactive wearable device 104 include digital eyeglasses, a wearable necklace, Google glass, a head-mounted optical device or any other wearable device which can integrate an image capturing module, one or more sensors and have networking capabilities to transmit/receive data. Examples of the one or more sensors include but may not be limited to gyroscope, precision sensors, proximity sensors and accelerometer. Further, the system 100 includes a retail store 106 in which the user 102 enters. The retail store 106 has one or more products 108a-f. These one or more products 108a-f may belong to different/similar categories. Examples of the categories of the one or more products 108a-f include but may not be limited to apparels, footwear, electronics, and home products. While shopping, the user 102 views/glances through the one or more products 108a-f in the retail store 106. However, the user 102 stares a first set of products 108a-b from these one or more products 108a-f in the retail store 106. For example, a user X wearing an interactive wearable device Y enters a wrist watch showroom Z and stares at two wrist watches Z1 and Z2 from a set of ten wrist watches.

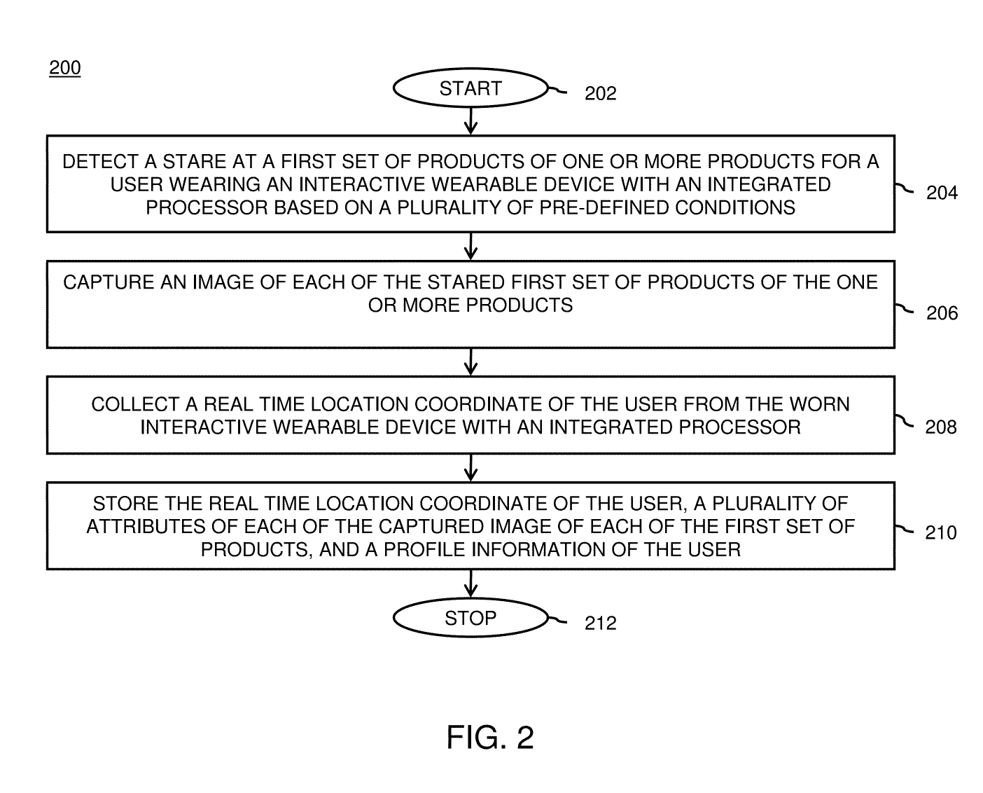

The interactive wearable device 104 stores and analyzes a plurality of attributes corresponding to the first set of products 108a-b stared at by the user 102. The plurality of attributes corresponding to the first set of products 108a-b include but may not be limited to product size, product category, product type, and product color. In addition, the interactive wearable device 104 stores the profile and coordinate information of the user 102. The interactive wearable device 104 transmits the stored data to an application server 110 (explained later in detail description of FIG. 2). Further, the application server 110 stores and analyzes the received data and further transmits the data to a third party 112 for targeting/re-targeting of advertisements (explained later in detailed description of FIG. 2). Examples of the third party 112 include but may not be limited to retail stores, online publishers, advertising agencies, shopping websites, social networking platforms and the like. For example, extending the above stated scenario, the wrist watch Z1 may be a titan watch of grey color and the wrist Z2 may be a Rolex watch of golden color. The application server 110 receives this information describing brand and color of the watches Z1 and Z2 from the interactive wearable device Y along with the other information related to the user X and the application server 110 transmits this information to one of the shopping website (say amazon).

It may be noted that in FIG. 1, the user 102 is described to stare at the first set of products 108a-b from the one or more products 108a-f in the retail store 106; however, those skilled in the art would appreciate that the user 102 can stare at more number of products in more than one retail stores. For example, a user X1 may stare at three wrist watches in a showroom A and two wallets in a showroom B. On the same lines, the system 100 is shown to have one user 102; however, those skilled in the art would appreciate that there can be more than one user wearing respective interactive wearable device in a retail store. Each of the respective interactive wearable devices transmits the respective product and respective user information in the retail store to the application server 110. For example, a user X2 may stare at two shirts in the showroom A and two foot-wears in a showroom C. This information may be transmitted to the application server 110.

FIG. 2 illustrates a flowchart 200 for collecting the data for targeting/re-targeting of advertisements, in accordance with various embodiments of the present disclosure. It may be noted that to explain various process steps of the flowchart 200, references will be made to the various elements of the FIG. 1. The flowchart 200 initiates at step 202. Following step 202, at step 204 the interactive wearable device 104 worn by the user 102 detects the stare at the first set of products 108a-b from the one or more products 108a-f for the user 102 based on a plurality of pre-defined conditions. In an embodiment of the present disclosure, a pre-defined condition is based on a threshold time duration. Continuing with the above stated example, when the user X gazes the two watches Z1 and Z2 for more than ten seconds, the interactive wearable device Y determine the gaze as stare. But, if the user X gazes the one or more products for just two or three seconds, then the interactive wearable device Y would not consider the gaze as stare. In an embodiment of the present disclosure, the interactive wearable device 104 consider the gaze as stare based on current technologies/algorithms presently known in the art.

At step 206, the interactive wearable device 104 captures an image of the stared first set of products 108a-b from the one or more products 108a-f. In an embodiment of the present disclosure, the interactive wearable device 104 processes the captured image of the stared first set of products 108a-b to fetch the plurality of attributes of the captured image of the first set of products 108a-b. The plurality of attributes includes but may not be limited to the product size, the product category, the product type, the product color and the like. The interactive wearable device 104 processes the captured image of the first set of products 108a-b using at least one of a third party image processing interfaces. Examples of the third party image processing interfaces include but may not be limited to moodstocks, imagemagicks and the magick++. I an embodiment of the present disclosure, any of the current technologies presently known in the art may be utilized for the third party image processing interfaces. Extending the above stated example, if the user X stares at the two watches Z1 and Z2, the interactive wearable device Y captures the images of both the watches Z1 and Z2. Accordingly, the interactive wearable device Y processes the images of Z1 and Z2 to extract the features (for example, say the watch Z1 is a grey colored titan watch and the watch Z2 is a golden colored Rolex watch).

Following step 206, at step 208, the interactive wearable device 104 collects a real time location coordinate of the user 102 using an in-built global positioning system (GPS) sensor. In an embodiment of the present disclosure, the interactive wearable device 104 analyzes the collected real time location coordinate of the user 102 and the captured image of the stared first set of products 108a-b. For example, if the user X stares the watches Z1 and Z2 at a shopping store M in an area P, then this information describing the location of the user X is collected and is analyzed.

At step 210, the interactive wearable device 104 stores the real time location coordinate of the user 102, the plurality of attributes of the captured image of the first set of products 108a-b, and a profile information of the user 102 in a file. The file can be in any of the format which include but may not be limited to XML and JSON. Considering the above stated example, the interactive wearable device Y stores the location (the mall M at the area P) of the user X, the features of Z1 (grey titan watch) and the features of Z2 (golden Rolex watch) and the profile information of the user X (for example, age, gender and the like). In an embodiment of the present disclosure, the GPS coordinates of the user 102 along with other attributes of the user 102 is collected and analyzed. For example, the interactive wearable device Y stores that the user X whose age is 35 years old and having his interest as reading books have entered in a watch shop near the shopping store M. In addition, the user X stared at the stated two wrists watches.

In an embodiment of the present disclosure, the interactive wearable device 104 transmits the real time location coordinate of the user 102, the plurality of attributes of the captured image of the first set of products 108a-b, and the profile information of the user 102 to the application server 110. Further, the application server 110 stores the collected real time location coordinate of the user 102 wearing the corresponding interactive head mounted optical device 104, the plurality of attributes of the captured image of the first set of products 108a-b stared at by the user 102, and the profile information of the user 102. It may be noted that the application server 110 is explained to receive a file from the user 102; however those skilled in the art would appreciate that the application server 110 store the information of more than one user. For example, the application server 110 receives the files from one or more users. For example, the application server 110 receives the respective files from a user Y and a user Z. The respective files contain the location and other attributes of the user Y and the user Z along with the product information on which these users stared at.

Accordingly, the application server 110 stores in a database and transmits the file containing the information of the products and the corresponding user profile information to at least one of the third party 112. In an embodiment of the present disclosure, the application server 110 analyses the stored files containing the product information and the user profile information to the third party 112. In an embodiment of the present disclosure, the application server 110 transmits the file on real time basis to the third party. In another embodiment of the present disclosure, the application server 110 transmits the file on periodic basis. In yet another embodiment of the present disclosure, the application server 110 transmits only the updates on real time basis to the third party. The third party 112 can be one or more retail stores, online publishers, advertising agencies, advertisement exchanges, shopping websites, social networking websites and the like. Continuing with the above stated example, the application server 110 stores the attributes of the Z1 (grey color titan watch), the attributes of the Z2 (golden color Rolex watch), location of the user X (the mall M at area P) and the profile information of the user X (for example, age, gender and the like). Similarly, the application server 110 stores and transmits the attributes of the products stared at by other users and the profile information of the users who stared at these products.

In an embodiment of the present disclosure, the interactive wearable device 104 directly transmits the profile of the user 102 and the information of the product 108a-b to the third party. In another embodiment of the present disclosure, the application server 110 analyses the files transmitted by each of the interactive wearable device and provide an inference report to the third party. For example, the application server 110 generates a report of the list of the users having age in the range of 30-35 and stared at a watch near a shopping mart near Florida.

The pre-defined set of reports is useful for effective targeting/re-targeting of advertisements. For example, the pre-defined set of reports can help the advertisers to know the most demanded product in the market. Also, when a user X wants a particular size of a product which is not available in stock, so, the advertisers can send reminders to the user X to help the user X know when the product is available. In another embodiment of the present disclosure, the third parties utilize the information/data received from the application server 110 according to respective marketing strategy. The flowchart 200 terminates at step 212.

It may be noted that the flowchart 200 is explained to have above stated process steps; however, those skilled in the art would appreciate that the flowchart 200 may have more/less number of process steps which may enable all the above stated embodiments of the present disclosure.

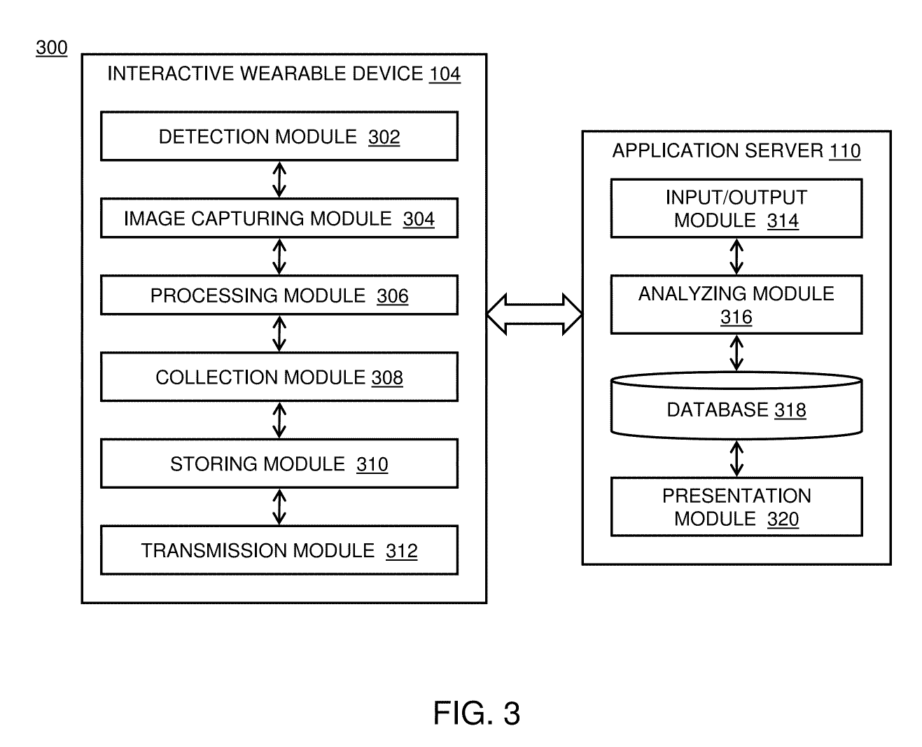

FIG. 3 illustrates a system 300 for showing an interaction between block diagrams of the interactive wearable device 104 and the application server 110, in accordance with various embodiments of the present disclosure. It may be noted that to explain system 300, references will be made to the system elements of FIG. 1 and process steps of FIG. 2. As mentioned above, the interactive wearable device 104 transmits the real time location coordinate of the user 102, the plurality of attributes of the captured image of the first set of products 108a-b, and the profile information of the user 102 to the application server 110 (explained in detailed description of the FIG. 2). The interactive wearable device 104 includes a detection module 302, an image capturing module 304, a processing module 306, a collection module 308, a storing module 310 and a transmission module 312.

The detection module 302 detects the stare at the first set of products 108a-b of one or more products 108a-f for the user 102 wearing an interactive wearable device 104 based on the plurality of pre-defined conditions. On the same lines, the one of the plurality of pre-defined conditions is based on the threshold time duration. In addition, the image capturing module 304 captures the image of each of the stared first set of products 108a-b of the one or more products 108a-f. Moreover, the processing module 306 processes the image of the stared first set of products 108a-b to fetch the plurality of attributes of each of the captured image of the first set of products 108a-b. Further, the processing module 306 processes the captured image of the first set of products 108a-b using at least one of the third party image processing interfaces including moodstocks, imagemagicks, magick++ and the like. The plurality of attributes includes but may not be limited to the product size, the product category, the product type, the product color and the like.

Going further, the collection module 308 collects the real time location coordinate of the user 102 from the worn interactive head mounted optical device 104. Furthermore, the processing module 306 analyzes the collected real time location coordinate of the user 102 and the captured image of the stared first set of products 108a-b. Moreover, the storing module 310 stores the real time location coordinate of the user 102, the plurality of attributes of each of the captured image of the first set of products 108a-b, and the profile information of the user 102. In addition, the transmission module 312 transmits the real time location coordinate of the user 102, the plurality of attributes of each of the captured image of the first set of products 108a-b, and the profile information of the user 102 to the application server 110.

On the same lines, the application server 110 includes an input/output module 314, an analyzing module 316, a database 318 and a presentation module 320. The input/output module 314 receives the real time location coordinates of the user 102, the plurality of attributes of the captured image of the first set of products 108a-b, and the profile information of the user 102 from the transmission module 312 of the interactive wearable device 104. The analyzing module 316 analyzes the collected real time location coordinate of the user 102, the plurality of attributes of each of the captured image of the first set of products 108a-b, and the profile information of the user 102. The database 318 stores the analyzed real time location coordinate of the user 102, the plurality of attributes of each of the captured image of the first set of products 108a-b, and the profile information of the user 102.

Further, the presentation module 320 generates the pre-determined set of reports. The pre-determined set of report includes information of the one or more products in demand (first set of products 108a-b). In addition, the presentation module 320 maintains the file to store the corresponding pre-determined set of reports. The file can be in at least one of the format including XML, JSON and the like. The pre-defined set of reports is useful for effective targeting of advertisements. For example, the pre-defined set of reports can help the advertisers to know the most demanded product and also in a case when a user wants a particular size of a product and is not available in stock, so, the advertisers can now send the reminders to the user to help the user know when the product can be available Further, the input/output module 314 transmits the pre-defined set of reports or a file having list of users along with the attributes of the products to at least one of the third party 112 for the targeted advertisement (as exemplarily illustrated in detailed description of FIG. 2).

It may be noted that in FIG. 3, the interactive wearable device 104 transmits the real time location coordinate of the user 102, the plurality of attributes of the captured image of the first set of products 108a-b, and the profile information of the user 102 to the application server 110; however, those skilled in the art would appreciate that the real time location coordinate and the profile information of more than one users can be transmitted to the application server 110.

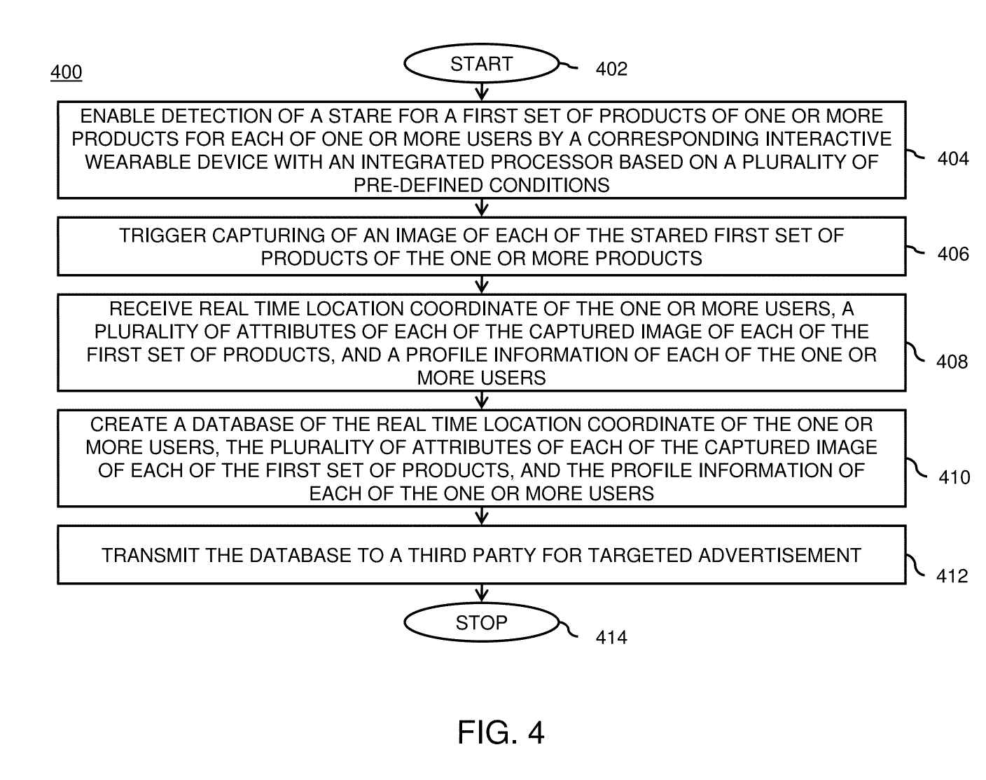

FIG. 4 illustrates a flowchart 400 for processing the collected data for targeting/re-targeting of advertisements, in accordance with various embodiments of the present disclosure. It may be noted that to explain various process steps of the flowchart 400, references will be made to the various elements of the FIG. 1 and the FIG. 3 and various process steps of the flowchart 200 of the FIG. 2. The flowchart 400 initiates at step 402. Following step 402, at step 404, the application server 110 enables detection of the stare for the first set of products 108a-b of one or more products 108a-f for each of one or more users by a corresponding interactive wearable device 104 based on the plurality of pre-defined conditions. The one of the plurality of pre-defined conditions is based on the threshold time duration.

At step 406, the application server 110 triggers capturing of each of the image of the stared first set of products 108a-b of the one or more products 108a-f. At step 408, the application server 110 receives the real time location coordinate of the one or more users, the plurality of attributes of each of the captured image of each of the first set of products 108a-b, and the profile information of each of the one or more users. At step 410, the application server 110 creates a database of the real time location coordinate of the one or more users, the plurality of attributes of each of the captured image of each of the first set of products 108a-b, and the profile information of each of the one or more users. At step 412, the application server 110 transmits the database to the third party 112 for targeting/retargeting of advertisements. For example, the application server 110 enables the detection of stare of user X on the watches Z1 and Z2 and triggers capturing of the image of the watches Z1 and Z2. The application server 110 receives and stores the location of the user X (say in a showroom S at an area A), the attributes of the watch Z1 (grey color titan watch) and the attributes of the watch Z2 (golden color Rolex watch) and the profile information of the user X (say age 22 and gender male). The application server 110 transmits this information to the advertising agency ABC for the purpose of better marketing of the two watches Z1 and Z2 or for promoting similar products.

It may be noted that the flowchart 400 is explained to have above stated process steps; however, those skilled in the art would appreciate that the flowchart 400 may have more/less number of process steps which may enable all the above stated embodiments of the present disclosure.

The above stated methods and system have many advantages. The method and system collects the data including shopping habits of the one or more users, shopping center visited by the one or more users and the like that normal advertising agencies cannot obtain from e-mail scanning. Further, the method and system allows the advertising agencies to know about the item the shopper is interested in and eventually collect all the data for marketing purpose. Furthermore, the method and system collects the shopping habits of the one or more users while they are performing their usual activities without interrupting them. Moreover, the method and system provides a ubiquitous way of information collecting and advertisement generating that does not force the one or more users to see the unwanted advertisements. In addition, the method and system not only tell if the shopper makes a purchase in store but also improves the accuracy of information collected from individual shoppers, thereby improving the efficiency of advertisement conversion.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method comprising:
detecting a stare at a first set of products of one or more products for a user wearing an interactive wearable device with an integrated processor based on a plurality of pre-defined conditions;
capturing an image of each of said stared first set of products of said one or more products;
collecting a real time location coordinate of said user from said worn interactive head mounted optical device with an integrated processor; and
storing said real time location coordinate of said user, a plurality of attributes of each of said captured image of each of said first set of products, and profile information of said user.

2. The method as recited in claim 1, further comprising processing said image of each of said stared first set of products to fetch said plurality of attributes of each of said captured image of each of said first set of products.

3. The method as recited in claim 1, further comprising analyzing said collected real time location coordinate of said user and said captured image of each of said stared first set of products.

4. The method as recited in claim 1, wherein at least one of said plurality of pre-defined conditions being based on a threshold time duration.

5. The method as recited in claim 1, further comprising transmitting said real time location coordinate of said user, said plurality of attributes of each of said captured image of each of said first set of products, and said profile information of said user to a server.

6. The method as recited in claim 5, further comprising creating a database by collecting said real time location coordinate of one or more users wearing corresponding said interactive head mounted optical device with an integrated processor, said plurality of attributes of each of said captured image of each of said first set of products being stared by each of said one or more users, and said profile information of each of said one or more users.

7. The method as recited in claim 6, further comprising transmitting said database to at least one of a third party for targeted advertisement.

8. A method comprising:
enabling detection of a stare for a first set of products of one or more products for each of one or more users by a corresponding interactive wearable device with an integrated processor based on a plurality of pre-defined conditions;
triggering capturing of an image of each of said stared first set of products of said one or more products;
receiving real time location coordinate of said one or more users, a plurality of attributes of each of said captured image of each of said first set of products, and a profile information of each of said one or more users;
creating a database of said real time location coordinate of said one or more users, said plurality of attributes of each of said captured image of each of said first set of products, and said profile information of each of said one or more users; and
transmitting said database to a third party for targeted advertisement.

9. The method as recited in claim 8, wherein said captured image of each of said stared first set of products being processed by a corresponding said interactive wearable device with an integrated processor to fetch said plurality of attributes of each of said captured image of each of said first set of products.

10. The method as recited in claim 8, wherein said collected real time location coordinate of said one or more users and said captured image of each of said stared first set of products being analyzed by a corresponding said interactive wearable device with an integrated processor.

11. The method as recited in claim 8, wherein creating said database comprises receiving a stored real time location coordinate of said one or more users, said plurality of attributes of each of said captured image of each of said first set of products, and said profile information of each of said one or more users.

12. The method as recited in claim 8, wherein at least one of said plurality of pre-defined conditions being based on a threshold time duration.

13. The method as recited in claim 8, wherein creating said database comprises processing said real time location coordinate of said one or more users, said plurality of attributes of each of said captured image of each of said first set of products, and said profile information of each of said one or more users to generate a pre-determined set of reports.

14. A system comprising:
a server;
one or more interactive wearable device with an integrated processor being worn by a corresponding one or more users, wherein each of said interactive wearable devices with an integrated processor comprises:
a detection module to detect a stare at a first set of products of one or more products for said user wearing said interactive wearable device with an integrated processor based on a plurality of pre-defined conditions;
an image capturing module to capture an image of each of said stared first set of products of said one or more products;
a collection module to collect a real time location coordinate of said user from said worn interactive head mounted optical device with an integrated processor; and
a storing module to store said real time location coordinate of said user, a plurality of attributes of each of said captured image of each of said first set of products, and a profile information of said user.
wherein each of said storing modules of each of said interactive wearable device with an integrated processor transmits said real time location coordinate of said corresponding user, said plurality of attributes of each of said captured image of each of said first set of products, and said profile information of said corresponding user.

15. The system as recited in claim 14, wherein said server being configured to
receive said real time location coordinate of said one or more users, said plurality of attributes of each of said captured image of each of said first set of products, and said profile information of each of said one or more users; and
create a database of said real time location coordinate of said one or more users, said plurality of attributes of each of said captured image of each of said first set of products, and said profile information of each of said one or more users.

16. The system as recited in claim 14, wherein said server being further configured to transmit said database to at least one of a third party for targeted advertisement.

17. The system as recited in claim 14, wherein each of said one or more interactive wearable device with an integrated processor being configured to process said image of each of said stared first set of products to fetch said plurality of attributes of each of said captured image of each of said first set of products.

18. The system as recited in claim 14, wherein each of said one or more interactive wearable device with an integrated processor being configured to analyze said collected real time location coordinate of said user and said captured image of each of said stared first set of products.

19. The system as recited in claim 14, wherein at least one of said plurality of pre-defined conditions being based on a threshold time duration.
